(19) United States
(12) Patent Application Publication
(10) Pub. No.: US 2019/0168339 A1
(43) Pub. Date: Jun. 6, 2019

(54) LASER PROCESSING MACHINE AND NOZZLE THEREOF

(71) Applicant: SUNG-LING FANG, TAINAN CITY (TW)

(72) Inventor: SUNG-LING FANG, TAINAN CITY (TW)

(21) Appl. No.: 15/832,952

(22) Filed: Dec. 6, 2017

(51) Int. Cl. B23K 26/14; B23K 26/21

(52) U.S. Cl. CPC B23K 26/1488; B23K 26/21

(57) ABSTRACT

A laser processing machine and a nozzle thereof are provided. The nozzle includes a nozzle body and a protector. The nozzle body defines a laser passage therein. The protector is coupled to an end portion of the nozzle body. The protector has a through hole communicating with the laser passage. The protector is made of a conductive material not containing a metallic element.

### FIELD OF THE INVENTION

The present invention relates to a processing machine and a nozzle thereof, and more particularly, to a laser processing machine and a nozzle thereof.

### BACKGROUND OF THE INVENTION

A conventional laser processing machine comprises a nozzle with a surface treatment at one end thereof, such that the nozzle is heat-resisting and won't be contaminated with a sputtering material to meet the processing requirements. For example, Chinese patent publication No. 1798628 discloses “a nozzle used for a processing machine, a nozzle used for welding, a method for manufacturing a nozzle used for a processing machine, and a method for manufacturing a nozzle used for welding”.

In the aforesaid patent, the surface of the metallic nozzle of the processing machine is formed with a hard ceramic coating film. The surface of the nozzle of the processing machine is protected by the hard ceramic coating film so as to prolong the service life of the nozzle of the processing machine. However, with the change in market demand, it is still necessary to develop different products in order to meet the diversified needs of the market.

### SUMMARY OF THE INVENTION

The primary object of the present invention is to provide a nozzle for a laser processing machine in order to meet the different needs of the market.

According to one aspect of the present invention, a nozzle for a laser processing machine is provided. The nozzle comprises a nozzle body and a protector. The nozzle body defines a laser passage therein. The protector is coupled to an end portion of the nozzle body. The protector has a through hole communicating with the laser passage. The protector is made of a conductive material not containing a metallic element.

According to another aspect of the present invention, a laser processing machine is provided. The laser processing machine comprises a laser processing machine body and a nozzle. The laser processing machine body includes a laser generating module and a focusing module. The focusing module corresponds to the laser generating module for focusing a laser generated by the laser generating module. The nozzle is mounted to the laser processing machine body. The nozzle comprises a nozzle body and a protector. The nozzle body defines a laser passage therein. The protector is coupled to an end portion of the nozzle body. The protector has a through hole communicating with the laser passage for the laser to pass therethrough. The protector is made of a conductive material not containing a metallic element.

Preferably, the material of the protector is graphite.

Preferably, the protector is coupled to the end portion in an embedded manner.

Preferably, the end portion defines an accommodation trough and an opening edge surrounding the accommodation trough. The accommodation trough is configured to receive the protector. The opening edge is provided with a chamfer.

Preferably, the end portion defines an accommodation trough and an opening edge surrounding the accommodation trough. The protector includes an insertion portion and a head portion. The head portion has a diameter greater than that of the insertion portion. The insertion portion is embedded into the accommodation trough. The head portion is against the opening edge. The head portion covers the opening edge. The through hole passes through the insertion portion and the head portion.

According to the above technical features, the present invention can achieve the following effects:

1. The nozzle body is combined with the protector made of a conductive material not containing a metallic element, which is distinguished from the existing ceramic coating technology.

2. The protector is coupled to the end portion of the nozzle body, thereby preventing the nozzle body from being contaminated with a sputtering material during the process.

3. The protector may be made of a graphite material, which has the properties of high temperature resistance, light weight, easy processing, and the like and can reduce the contamination of a sputtering material.

4. The protector is coupled to the end portion of the nozzle body in an embedded manner, which can be assembled easily.

5. The opening edge is provided with the chamfer to reduce the surface facing a sputtering material so as to reduce the possibility of contamination.

6. The end portion of the nozzle body can be covered by the head portion having a great diameter so that the end portion of the nozzle body won't have excessive contamination of the sputtering material.

### BRIEF DESCRIPTION OF THE DRAWINGS

FIG. 1 is a planar schematic view of the laser processing machine according to an embodiment of the present invention;

FIG. 2 is a perspective exploded view of the nozzle according to the embodiment of the present invention;

FIG. 3 is a cross-sectional view of the nozzle according to the embodiment of the present invention;

FIG. 4 is a cross-sectional view according to the embodiment of the present invention when in use;

FIG. 4A is a partially enlarged view in FIG. 5; and

FIG. 5 is a cross-sectional view according to another embodiment of the present invention.

### DETAILED DESCRIPTION OF THE PREFERRED EMBODIMENTS

Embodiments of the present invention will now be described, by way of example only, with reference to the accompanying drawings.

According to the above technical features, the main effects of the laser processing machine and the nozzle of the present invention will be clearly shown in the following embodiments.

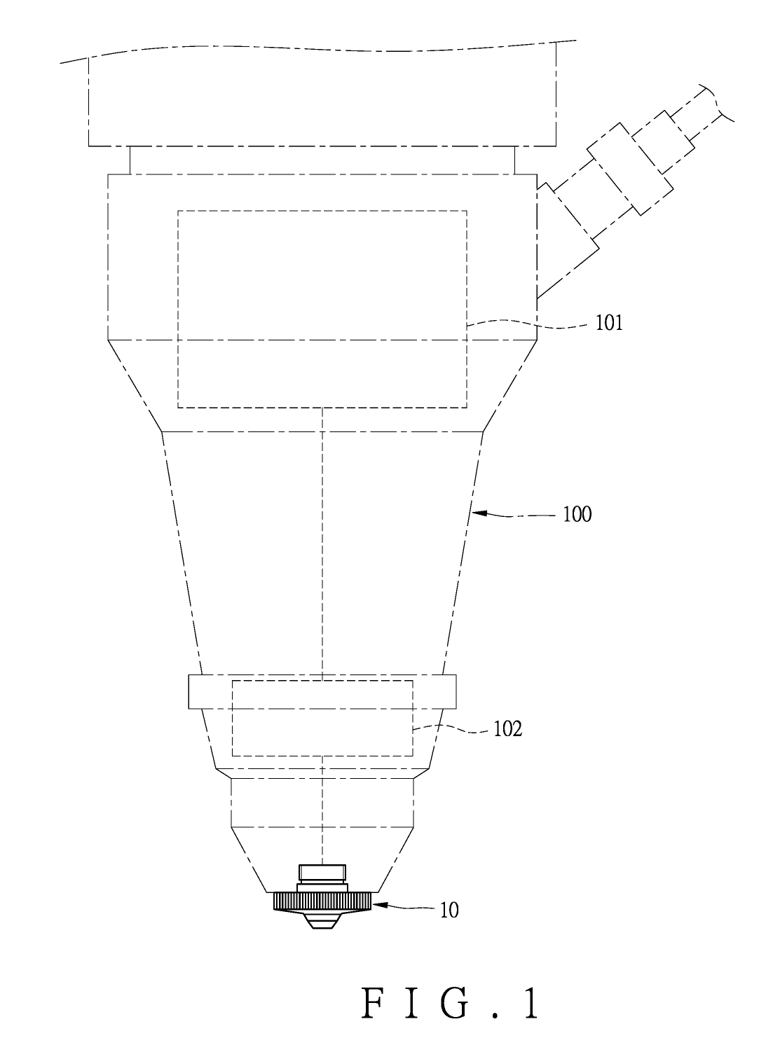

Referring to FIG. 1, a laser processing machine according to an embodiment of the present invention comprises a laser processing machine body (100) and a nozzle (10) mounted to the laser processing machine body (100). The laser processing machine body (100) includes a laser generating module (101) and a focusing module (102). The focusing module (102) corresponds to the laser generating module (101) for focusing a laser generated by the laser generating module (101). It should be noted that the laser generating module (101) and the focusing module (102) of the laser processing machine body (100) are not the improved key point of the present invention and are common knowledge in the art. Therefore, the detailed description is omitted herein.

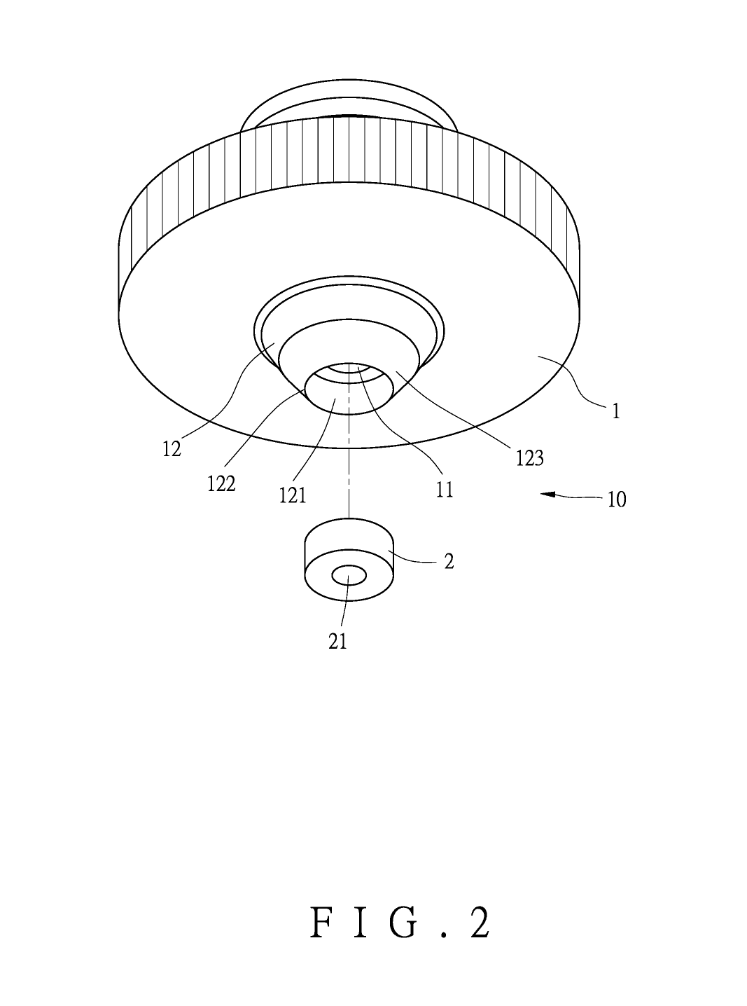

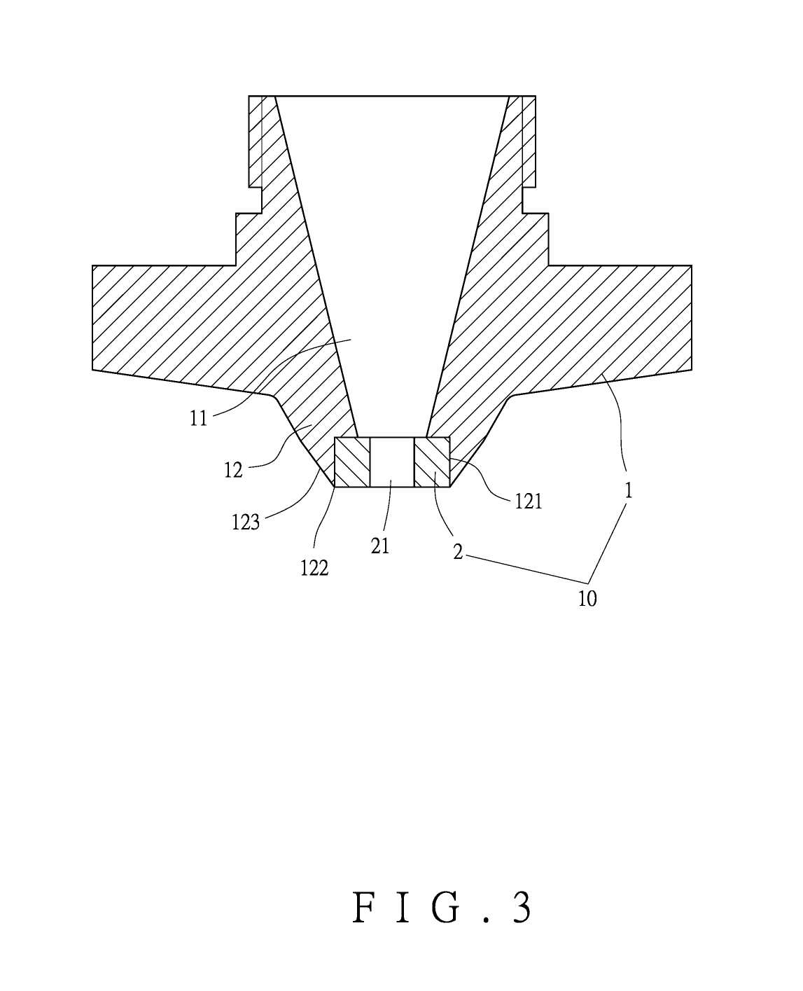

Please refer to FIG. 2 and FIG. 3. The nozzle (10) includes a nozzle body (1) and a protector (2). The nozzle body (1) may be made of copper or copper alloy, which facilitates manufacture. The nozzle body (1) defines a laser passage (11) therein. In this embodiment, an end portion (12) of the nozzle body (1) defines an accommodation trough (121) and an opening edge (122) surrounding the accommodation trough (121).

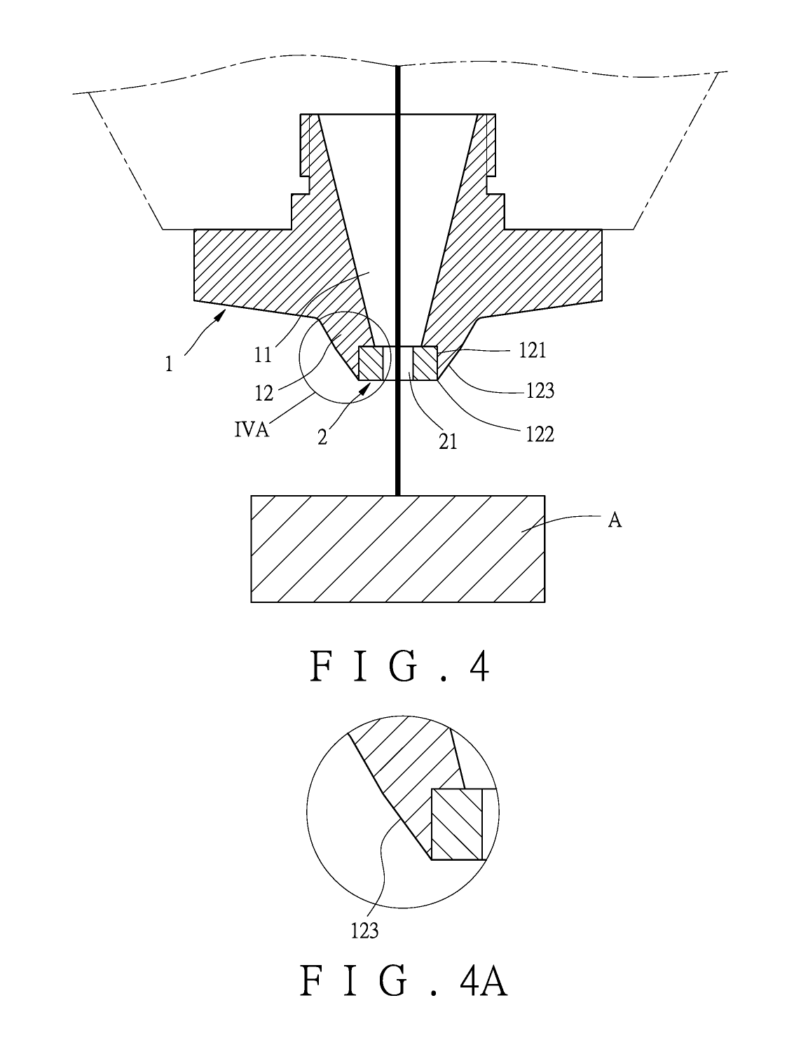

Referring to FIG. 3 and FIG. 4, 4A, the protector (2) is coupled to the end portion (12) of the nozzle body (1) in an embedded manner, which can be assembled easily. In this embodiment, the protector (2) is embedded in the accommodation trough (121) of the end portion (12). Preferably, the opening edge (122) is provided with a chamfer (123) to reduce the surface facing a sputtering material so as to reduce the possibility of contamination. The protector (2) has a through hole (21) communicating with the laser passage (11). The protector (2) is made of a conductive material not containing a metallic element, which is conductive and can be used for distance measurement of a workpiece (A), electric discharge machining and the like. The material of the protector (2) may be graphene, graphite or the like. Graphite has the properties of high temperature resistance, light weight, easy processing, and the like and can reduce the contamination of the sputtering material.

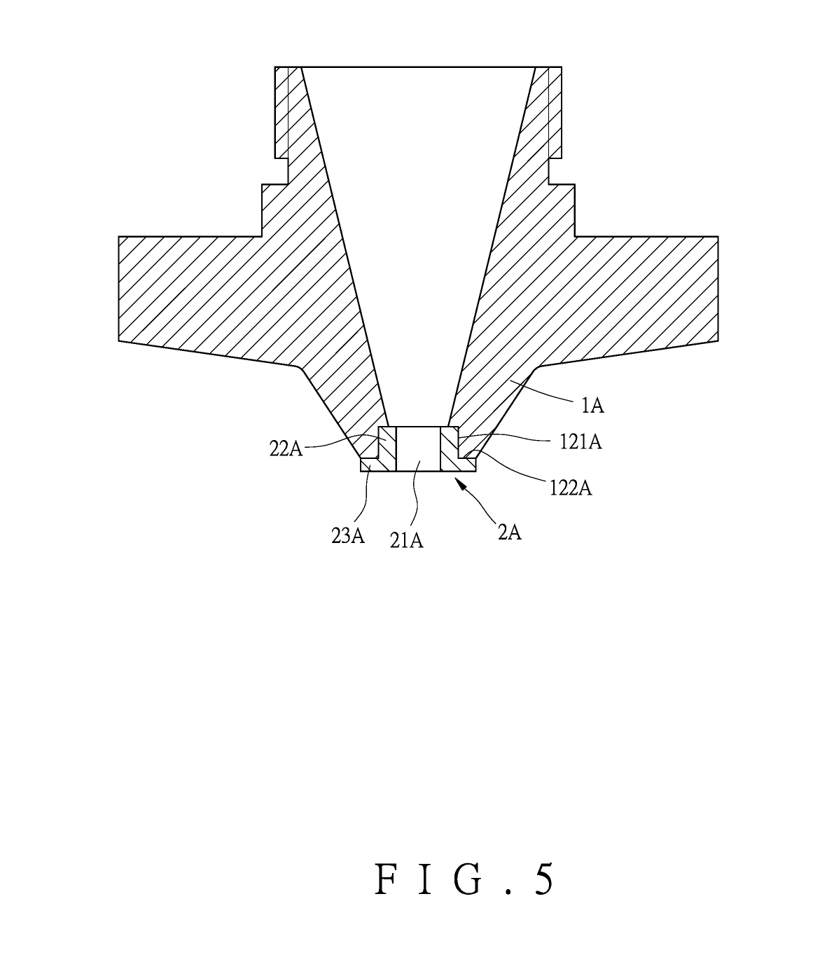

Referring to FIG. 5, another embodiment of the present invention comprises a nozzle body (1A) and a protector (2A) as in the previous embodiment. An end portion (12A) of the nozzle body (1A) defines an accommodation trough (121A) and an opening edge (122A) surrounding the accommodation trough (121A).

Referring again to FIG. 5, another embodiment of the present invention differs from the previous embodiment in that the protector (2A) includes an insertion portion (22A) and a head portion (23A). A through hole (21A) passes through the insertion portion (22A) and the head portion (23A). The head portion (23A) has a diameter greater than that of the insertion portion (22A). The insertion portion (22A) is inserted into the accommodation trough (121A). The head portion (23A) is against the opening edge (122A), and the head portion (23A) covers the opening edge (122A). Therefore, the end portion (12A) of the nozzle body (1A) can be covered by the head portion (23A) having a great diameter so that the end portion (12A) of the nozzle body (1A) won't have excessive contamination of the sputtering material.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A nozzle for a laser processing machine, comprising:
a nozzle body, the nozzle body defining a laser passage therein; and
a protector, coupled to an end portion of the nozzle body, the protector having a through hole communicating with the laser passage, the protector being made of a conductive material not containing a metallic element.

2. The nozzle as claimed in claim 1, wherein the material of the protector is graphite.

3. The nozzle as claimed in claim 1, wherein the protector is coupled to the end portion in an embedded manner.

4. The nozzle as claimed in claim 3, wherein the end portion defines an accommodation trough and an opening edge surrounding the accommodation trough, the accommodation trough is configured to receive the protector, and the opening edge is provided with a chamfer.

5. The nozzle as claimed in claim 3, wherein the end portion defines an accommodation trough and an opening edge surrounding the accommodation trough, the protector includes an insertion portion and a head portion, the head portion has a diameter greater than that of the insertion portion, the insertion portion is embedded into the accommodation trough, the head portion is against the opening edge, the head portion covers the opening edge, and the through hole passes through the insertion portion and the head portion.

6. A laser processing machine, comprising:
a laser processing machine body, the laser processing machine body including a laser generating module and a focusing module, the focusing module corresponding to the laser generating module for focusing a laser generated by the laser generating module; and
a nozzle mounted to the laser processing machine body, the nozzle comprising a nozzle body and a protector, the nozzle body defining a laser passage therein, the protector being coupled to an end portion of the nozzle body, the protector having a through hole communicating with the laser passage for the laser to pass therethrough, the protector being made of a conductive material not containing a metallic element.

7. The laser processing machine as claimed in claim 6, wherein the material of the protector is graphite.

8. The laser processing machine as claimed in claim 6, wherein the protector is coupled to the end portion in an embedded manner.

9. The laser processing machine as claimed in claim 8, wherein the end portion defines an accommodation trough and an opening edge surrounding the accommodation trough, the accommodation trough is configured to receive the protector, and the opening edge is provided with a chamfer.

10. The laser processing machine as claimed in claim 8, wherein the end portion defines an accommodation trough and an opening edge surrounding the accommodation trough, the protector includes an insertion portion and a head portion, the head portion has a diameter greater than that of the insertion portion, the insertion portion is embedded into the accommodation trough, the head portion is against the opening edge, the head portion covers the opening edge, and the through hole passes through the insertion portion and the head portion.
